(19) United States
(12) Patent Application Publication
(10) Pub. No.: US 2026/0252678 A1
(43) Pub. Date: Aug. 27, 2026

(54) FIRMWARE CONFIGURATION METHOD AND SYSTEM OF RETIMER CHIP, ELECTRONIC DEVICE, AND MEDIUM

(71) Applicant: Celestica Technology Consultancy (Shanghai) Co. Ltd, Shanghai (CN)

(72) Inventors: Zhongfu Huang, Shanghai (CN); Jinbin Qiu, Shanghai (CN); Feng Chen, Shanghai (CN)

(21) Appl. No.: 19/331,927

(22) Filed: Sep. 17, 2025

(30) Foreign Application Priority Data
Feb. 21, 2025 (CN) 2025102007681

(51) Int. Cl. G06F 21/44; G06F 9/445

(52) U.S. Cl. CPC G06F 21/44; G06F 9/44505

(57) ABSTRACT

A firmware configuration method and system of a Retimer chip, an electronic device, and a medium are provided in the disclosure. The firmware configuration method of the Retimer chip includes: acquiring a storage in-place signal and a storage node authentication signal; causing a BMC to write corresponding firmware configuration to the Retimer chip based on the storage in-place signal and the storage node authentication signal; and changing CPU configuration and a communication link of a storage node based on the storage in-place signal, so that the CPU configuration and the communication link are adapted to the firmware configuration of the Retimer chip.

### FIELD OF TECHNOLOGY

The present disclosure belongs to the technical field of storage servers, and in particular relates to a firmware configuration method and system of a Retimer chip, an electronic device, and a medium.

### BACKGROUND

A non-transparent bridge (NTB) is a bridging technology for connecting different bus segments or different bus architectures, which is mainly used for resource isolation, signal conversion and performance optimization. In a PCIe (Peripheral Component Interconnect Express) interface, NTB technology allows devices at different bus segments to communicate with each other through functions such as address mapping, signal conversion and data forwarding, while preventing direct access between the devices, thus improving security and stability of a system. The NTB technology is widely applied in multiprocessor systems, heterogeneous computing environments and distributed storage systems, especially in scenes where resources need to be isolated or cross-domain communication needs to be realized.

However, with increasing complexity of a PCIe interconnection system, a length of a communication link and signal integrity become challenges. In order to extend a transmission distance of PCIe and ensure signal quality, a Retimer chip is generally needed. A Retimer can effectively reduce signal attenuation and jitter through signal conditioning and clock recovery functions, thus supporting a longer physical transmission distance. However, the Retimer chip needs to burn different firmwares in different application scenarios, which poses flexibility and compatibility problems. For example, in an NTB application scenario, a primary storage node and a secondary storage node generally need to be configured with different firmwares. Even if hardwares of these two nodes are exactly the same, users cannot freely exchange nodes in position. In addition, a hardware with a fixed firmware cannot support various application scenarios. For example, the same one device cannot support both an NTB X16 mode and an NTB X8+4* PCIe X2 mode without changing the hardware.

### SUMMARY

The present disclosure provides a firmware configuration method and system of a Retimer chip, an electronic device, and a medium, which can dynamically adapt the Retimer chip to different application scenarios and improve compatibility and flexibility.

In a first aspect, a firmware configuration method of a Retimer chip is provided in the present disclosure, which includes:
acquiring a storage in-place signal and a storage node authentication signal;
causing a baseboard management controller (BMC) to write corresponding firmware configuration to the Retimer chip based on the storage in-place signal and the storage node authentication signal; and
changing CPU configuration and a communication link of a storage node based on the storage in-place signal, so that the CPU configuration and the communication link are adapted to the firmware configuration of the Retimer chip.

In an embodiment of the first aspect, when an external storage device is not accessed, the BMC is caused to write NTB firmware configuration to the Retimer chip based on the storage in-place signal; and
the BMC is caused to write NTB firmware configuration of a first storage node or NTB firmware configuration of a second storage node to the Retimer chip based on the storage node authentication signal.

In an embodiment of the first aspect, when an external storage device is accessed, the BMC is caused to write NTB and PCIe synchronous firmware configuration to the Retimer chip based on the storage in-place signal; and
the BMC is caused to write NTB and PCIe synchronous firmware configuration of the first storage node or NTB and PCIe synchronous firmware configuration of the second storage node to the Retimer chip based on the storage node authentication signal.

In an embodiment of the first aspect, when the external storage device is not accessed, the CPU configuration is changed to NTB configuration based on the storage in-place signal, so that the CPU configuration is adapted to the NTB firmware configuration of the Retimer chip.

In an embodiment of the first aspect, when the external storage device is accessed, the CPU configuration is changed to NTB and PCIe configuration based on the storage in-place signal, so that the CPU configuration is adapted to the NTB and PCIe synchronous firmware configuration of the Retimer chip.

In an embodiment of the first aspect, when the external storage device is not accessed, a communication link switching chip is caused to switch the communication link to an NTB path based on a communication link switching signal, so that the communication link is adapted to the NTB firmware configuration of the Retimer chip.

In an embodiment of the first aspect, when the external storage device is accessed, the communication link switching chip is caused to switch the communication link to a PCIe path based on the communication link switching signal, so that the communication link is adapted to the NTB and PCIe synchronous firmware configuration of the Retimer chip.

In a second aspect, a firmware configuration system of a Retimer chip is provided in the present disclosure, which includes:
an acquisition module configured to acquire a storage in-place signal and a storage node authentication signal;
a writing module configured to cause a BMC to write corresponding firmware configuration to the Retimer chip based on the storage in-place signal and the storage node authentication signal; and
a configuration module configured to change CPU configuration and a communication link of a storage node based on the storage in-place signal, so that the CPU configuration and the communication link are adapted to the firmware configuration of the Retimer chip.

In a third aspect, an electronic device is provided in the present disclosure, which includes a processor and a memory. The memory is configured to store computer programs, the processor is in communication connection with the memory, and the processor is configured to execute the computer programs stored in the memory so as to execute the firmware configuration method of the Retimer chip described in the first aspect of the present disclosure.

In a fourth aspect, a computer-readable storage medium having a computer program stored thereon is provided in the present disclosure. The computer program, when executed by a processor, implements the firmware configuration method of the Retimer chip described in the first aspect of the present disclosure.

As described above, the firmware configuration method and system of the Retimer chip, the electronic device, and the medium described in the present disclosure have the following beneficial effects. The BMC can be caused to automatically write the corresponding firmware configuration to the Retimer chip according to different application scenarios, so as to realize automatic updating of firmware configuration of the Retimer chip, so that users can freely exchange nodes in position while supporting the NTB firmware configuration and the NTB and PCIe synchronous firmware configuration without changing hardware, which realizes compatibility between PCIe SSD and NTB, prolongs a communication distance and has strong compatibility and flexibility.

### BRIEF DESCRIPTION OF DRAWINGS

FIG. 1 shows a schematic diagram of an architecture of a storage node application scenario provided in an embodiment of the present disclosure.

FIG. 2 shows a flowchart of a firmware configuration method of a Retimer chip according to an embodiment of the present disclosure.

FIG. 3 shows a schematic diagram of an architecture of a firmware configuration system of a Retimer chip according to an embodiment of the present disclosure.

FIG. 4 shows a schematic diagram of an architecture of an electronic device according to an embodiment of the present disclosure.

### DETAILED DESCRIPTION

Implementations of the present disclosure are illustrated in the following through specific examples, and other advantages and effects of the disclosure can be easily understood by those skilled in the art from contents disclosed in this specification. The present disclosure can also be implemented or applied through other different specific embodiments, and details in this specification can be modified or changed based on different viewpoints and applications without departing from the spirit of the present disclosure. It should be noted that following embodiments and features in the embodiments can be combined mutually in the case of no conflict.

It should be noted that views provided in the following embodiments only illustrate a basic idea of the present disclosure in a schematic way, and thus only components related to the present disclosure are shown in the views instead of being drawn according to a number, shapes and sizes of the components in actual implementations. In actual implementations, modes, number and scales of the components can be changed arbitrarily, and a layout of the components may be more complicated.

In addition, it should be understood that, unless otherwise specified or pointed out, terms “first” and “second” appearing in the specification are only used to distinguish various components, elements, steps, etc. in the specification, but not to indicate a logical relationship or a sequential relationship among various components, elements, steps, etc., nor can be understood as indicating or implying relative importance or implicitly indicating a number of indicated technical features.

A firmware configuration method and system of a Retimer chip, an electronic device, and a medium are provided in embodiments of the present disclosure, in which a BMC can be caused to automatically write corresponding firmware configuration to the Retimer chip according to different application scenarios, so as to realize automatic updating of firmware configuration of the Retimer chip, so that users can freely exchange nodes in position, while supporting the NTB firmware configuration and the NTB and PCIe synchronous firmware configuration without changing hardwares, which realizes compatibility between PCIe SSD and NTB, prolongs a communication distance and has strong compatibility and flexibility.

In the following, the present disclosure will be described by taking an application scenario of two storage nodes as an example.

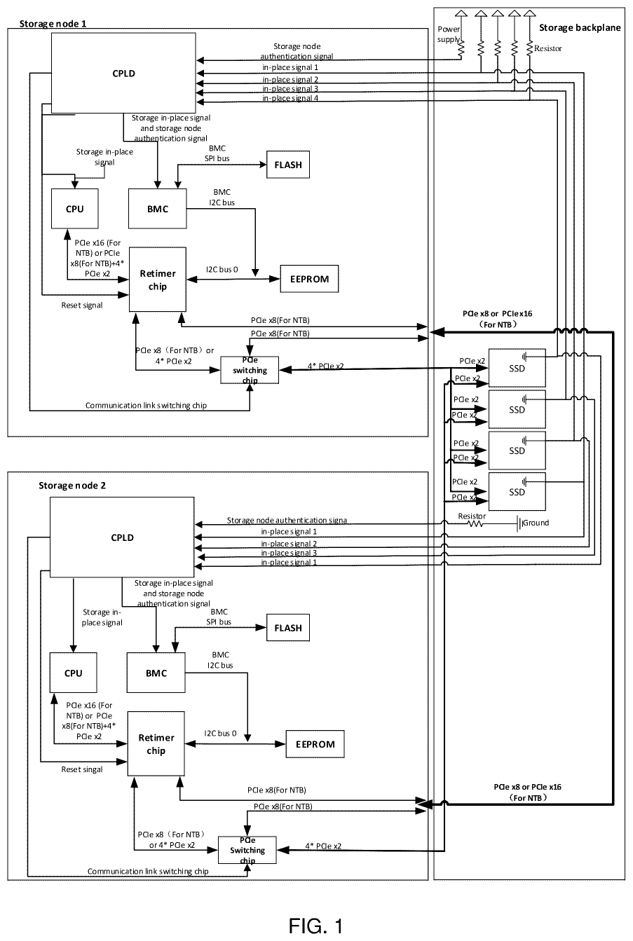

As shown in FIG. 1, this embodiment provides an architectural diagram of a storage node application scenario. It should be noted that a structure shown in FIG. 1 is only an example, and is not the only structure for performing this method. As shown in FIG. 1, the application scenario is composed of following parts.

Storage node, which includes two independent same storage nodes, including a storage node 1 and a storage node 2 which are interconnected by an NTB.

Primary Node, namely, a preferred node, which can be a master node on a bus and is used for interconnection between different nodes, such as the NTB.

Secondary Node, namely, a backup node, which can be a slave node on an interconnection bus. When the master node is with a fault or in an abnormal situation, it can undertake all of operation tasks.

Storage backplane, which is a backplane into which SSD hard disks are inserted.

CPU, namely, a central processing unit, and in the present disclosure, configuration of PCIE is changed by CPU control to realize switching of different applications.

CPLD, namely, a programmable logic device, which performs digital logic on in-place signals and outputs relevant logic output signals to the CPU and a BMC.

BMC, namely, a baseboard management controller, which is configured to monitor and manage a host system.

Retimer chip: when a signal passes through the Retimer chip, the signal is reconstructed by an internal clock, so that transmission energy of the signal is increased and a transmission distance of the signal is increased, and the Retimer chip needs firmwares to operate normally.

PCIe, which is a high-speed serial computer expansion bus standard and a most common interface in motherboards, adopts a high-speed differential bus and an end-to-end connection mode to provide a greater bus bandwidth, and is often used to interconnect external devices.

PCIe switching chip, which can control switching from one PCIe channel to two PCIe channels by GPIO (General Purpose Input Output). A host can be connected to different PCIe devices through the PCIe switching chip.

EEPROM, which stores firmware required for operations of the Retimer chip.

NTB, namely, a non-transparent bridge, which translates corresponding data by address mapping so as to realize data communication between storage nodes.

SSD hard disk, which stores information storage medium.

FLASH, which stores firmware and other files required for BMC operations.

Specifically, in this storage node application scenario, the Retimer chip is connected to the EEPROM through I2C to read the firmware required for normal operations. The BMC is connected to the EEPROM through I2C, so that different firmware configuration can be written according to application scenarios, and thus the Retimer chip can read corresponding firmware configuration from the EEPROM. The BMC is connected to the FLASH through SPI, which can read firmware required for operations and files with managed configuration.

Specifically, in this storage node application scenario, a level of a storage in-place signal is obtained according to an in-place signal of the SSD storage hard disk, and a level of a storage node authentication signal is determined according to whether the preferred node or the backup node is used for interconnection. Then, the CPLD sends the storage in-place signal and the storage node authentication signal to the BMC, so that the BMC can write the firmware of the Retimer chip according to the storage in-place signal and storage node authentication signal. In addition, the CPLD also sends the storage in-place signal to the CPU. After the CPU receives the signal, it changes the CPU configuration to NTB configuration or NTB and PCIe configuration. Meanwhile, the CPLD outputs a communication link switching signal according to the storage in-place signal, so that the communication link switching chip switches the communication link to an NTB path (a PCIe x8 (For NTB) path) or a PCIe path (a 4* PCIe X2 Path).

In the following, technical schemes in the embodiments of the present disclosure will be described in detail with reference to the figures of the embodiments of the disclosure.

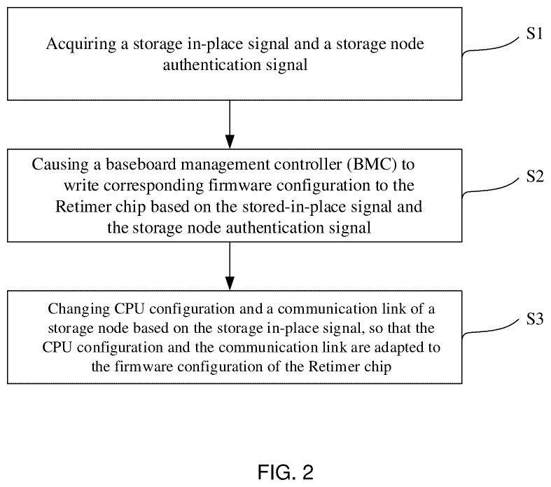

As shown in FIG. 2, a firmware configuration method of a Retimer chip is provided in this embodiment, which includes following steps S1 to S3.

S1, a storage in-place signal and a storage node authentication signal are acquired.

Specifically, the storage in-place signal refers to a signal determined by CPLD according to whether an external SSD storage hard disk is connected.

In some embodiments, when the SSD storage hard disk is not accessed to the storage node, a power supply is on through a resistor by default. Therefore, storage in-place signals of SSD storage hard disks are all high-level signals, and thus at this time, the CPLD can output the storage in-place signal to the CPU as a high-level signal according to the storage in-place signals of the SSD storage hard disks.

In some embodiments, when the SSD storage hard disk is accessed to the storage node, because an in-place pin of the SSD is grounded inside the SSD, when any of SSD storage hard disks is connected to the storage node, a stored in-place signal of a corresponding SSD storage hard disk is a low-level signal. At this time, the CPLD can output the storage in-place signal to the CPU and the BMC as a low-level signal according to the storage in-place signal of the SSD storage hard disk.

It should be noted that no matter how many external SSD storage hard disks exist, as long as one of the SSD storage hard disks is accessed to the storage node, the CPLD outputs the storage in-place signal to the CPU and the BMC as a low-level signal.

Specifically, when a plurality of storage nodes are interconnected, the CPLD determines which storage node a signal is from according to the storage node authentication signal, and the storage node authentication signal can be output to the BMC so that the BMC can write corresponding firmware configuration to a corresponding storage node. For example, in some embodiments, a first storage node is a master node with a storage node authentication signal being a high-level signal, while a second storage node is a slave node with a storage node authentication signal being a low-level signal.

S2, a BMC is caused to write corresponding firmware configuration to the Retimer chip based on the storage in-place signal and the storage node authentication signal.

Specifically, the firmware configuration of the Retimer chip is stored in a fixed area of the FLASH of the BMC (a memory of the BMC). After receiving the storage in-place signal and the storage node authentication signal sent by the CPLD, the BMC writes the corresponding firmware configuration to the EEPROM according to the storage in-place signal and the storage node authentication signal, so that the Retimer chip can read the corresponding firmware configuration. That is, the BMC writes the corresponding firmware configuration to the Retimer chip according to the storage in-place signal and the storage node authentication signal, so that the Retimer chip can be adapted to different application scenarios.

In some embodiments, the firmware configuration stored in the fixed area of the FLASH of the BMC involves:
firmware 1: a master controller NTB PCIE*16 (NTB firmware configuration of the first storage node)
firmware 2: a secondary controller NTB PCIE*16 (NTB firmware configuration of the second storage node)
firmware 3: a master controller NTB PCIE*8+4*PCIE*2 (NTB and PCIe synchronous firmware configuration of the first storage node)
firmware 4: a secondary controller NTB PCIE*8+4*PCIE*2 (NTB and PCIe synchronous firmware configuration of the second storage node).

The step in which the BMC is caused to write the corresponding firmware configuration to the Retimer chip based on the storage in-place signal and the storage node authentication signal specifically includes following content.

(1) When an external storage device is not accessed, the BMC is caused to write NTB firmware configuration to the Retimer chip based on the storage in-place signal; and the BMC is caused to write NTB firmware configuration of a first storage node or NTB firmware configuration of a second storage node to the Retimer chip based on the storage node authentication signal.

In some embodiments, when the external storage device is not accessed, and the BMC obtains the storage node authentication signal which is at a high level, and when the storage in-place signal is at a high level, the BMC writes the firmware 1, that is the NTB firmware configuration of the first storage node (the main controller NTB PCIE*16), to the Retimer chip according to the storage node authentication signal and the storage in-place signal.

In some embodiments, when the external storage device is not accessed, and the BMC obtains the storage node authentication signal which is at a low level, and when the storage in-place signal is at the high level, the BMC writes the firmware 2, that is the NTB firmware configuration of the second storage node (the secondary controller NTB PCIE*16), to the Retimer chip according to the storage node authentication signal and the storage in-place signal.
(2) When an external storage device is accessed, the BMC is caused to write NTB and PCIe synchronous firmware configuration to the Retimer chip based on the storage in-place signal; and the BMC is caused to write NTB and PCIe synchronous firmware configuration of the first storage node or NTB and PCIe synchronous firmware configuration of the second storage node to the Retimer chip based on the storage node authentication signal.

In some embodiments, when the external storage device is accessed, and the BMC obtains the storage node authentication signal which is at a high level, and when the storage in-place signal is at the low level, the BMC writes the firmware 3, that is the NTB and PCIe synchronous firmware configuration of the first storage node (the main controller NTB PCIE*8+4*PCIE*2), to the Retimer chip according to the storage node authentication signal and the storage in-place signal.

In some embodiments, when the external storage device is accessed, and the BMC obtains the storage node authentication signal which is at a low level, and when the storage in-place signal is at the low level, the BMC writes the firmware 4, that is the NTB and PCIe synchronous firmware configuration of the second storage node (the secondary controller NTB PCIE*8+4*PCIE*2), to the Retimer chip according to the storage node authentication signal and the storage in-place signal.

In addition, as shown in FIG. 1, after the BMC writes the corresponding firmware configuration to the Retimer chip according to the storage in-place signal and the storage node authentication signal, the CPLD sends a reset signal to restart the Retimer chip to enable the firmware configuration.

S3, CPU configuration and a communication link of a storage node are changed based on the storage in-place signal, so that the CPU configuration and the communication link are adapted to the firmware configuration of the Retimer chip.

Specifically, in the present disclosure, on one hand, different firmware configuration is written to the Retimer chip through the BMC, and on the other hand, the CPU configuration and the communication link of the storage node are adaptively changed based on the different firmware configuration of the Retimer chip, so as to meet requirements of different application scenarios.

Specifically, as shown in FIG. 1, the CPLD sends the storage in-place signal to the CPU, so that a PCIe control module in the CPU can be caused to switch the CPU configuration to realize switching for different applications. The CPU configuration includes NTB configuration, and NTB and PCIe configuration.

In some embodiments, when the external storage device is not accessed, the CPU configuration is changed to the NTB configuration based on the storage in-place signal, so that the CPU configuration is adapted to the NTB firmware configuration of the Retimer chip. That is, the CPLD inputs a high-level storage in-place signal to the CPU, which changes the CPU configuration to the NTB configuration (PCIE x16 (For NTB)). At this time, since the storage in-place signal is at the high level, in fact, firmware configuration written by the BMC to the Retimer chip is also the NTB configuration, and thus the CPU configuration is adapted to the firmware configuration of the Retimer chip.

In some embodiments, when the external storage device is accessed, the CPU configuration is changed to the NTB and PCIe configuration based on the storage in-place signal, so that the CPU configuration is adapted to the NTB and PCIe synchronous firmware configuration of the Retimer chip. That is, the CPLD inputs a low-level storage in-place signal to the CPU, which changes the CPU configuration to the NTB and PCIe configuration (PCIE x8 (For NTB)+4 PCIE x2 (For ssd)). At this time, since the storage in-place signal is at the low level, in fact, firmware configuration written by the BMC to the Retimer chip is also the NTB and PCIe synchronous firmware configuration, and thus the CPU configuration is adapted to the firmware configuration of the Retimer chip.

Specifically, as shown in FIG. 1, the CPLD sends a communication link switching signal to a communication link switching chip (which is shown as the PCIe switching chip in FIG. 1) according to whether an external storage device is accessed, so that the communication link switching chip switches the communication link of the storage node to meet different application scenarios. The communication link includes an NTB path and a PCIe path.

In some embodiments, when the external storage device is not accessed, a communication link switching chip is caused to switch the communication link to the NTB path based on the communication link switching signal, so that the communication link is adapted to the NTB firmware configuration of the Retimer chip. That is, when the in-place signals of the SSD storage hard disks are all at high level, the CPLD outputs the communication link switching signal to the communication link switching chip, so that the communication link switching chip switches the communication link to the NTB path. At this time, the communication link of the storage node is configured in an NTB x16 mode, because a full SSD is not needed in practical applications. At this time, the two storage nodes (the first storage node and the second storage node) are connected through an NTB x16 bus to realize a maximum interconnection bandwidth.

In some embodiments, when the external storage device is accessed, the communication link switching chip is caused to switch the communication link to the PCIe path based on the communication link switching signal, so that the communication link is adapted to the NTB and PCIe synchronous firmware configuration of the Retimer chip. That is, when an in-place signal of any of the SSD storage hard disks is at low level, the CPLD outputs the communication link switching signal to the communication link switching chip, so that the communication link switching chip switches the communication link to the SSD PCIE path. At this time, the communication link of the storage node is configured in NTB x8 and 4x PCIe x2 modes. The two storage nodes (the first storage node and the second storage node) are connected through a NTB PCIe x8 bus, for which four PCIe x2 SSDs can be added. The two storage nodes are interconnected with an external storage device through a PCIe bus.

A protection scope of the firmware configuration method of the Retimer chip described in the embodiment of the present disclosure is not limited to an execution order of steps listed in this embodiment, and all of schemes realized by adding, subtracting and replacing steps in related art according to the principle of the present disclosure are encompassed in the protection scope of the present disclosure.

A firmware configuration system of a Retimer chip is further provided in an embodiment of the present disclosure, which can realize the firmware configuration method of the Retimer chip described in the present disclosure. However, an apparatus for realizing the firmware configuration method of the Retimer chip described in the present disclosure includes but is not limited to a structure of the firmware configuration system of the Retimer chip listed in this embodiment, and any structural modification and replacement in related art according to the principle of the present disclosure are encompassed in the protection scope of the present disclosure.

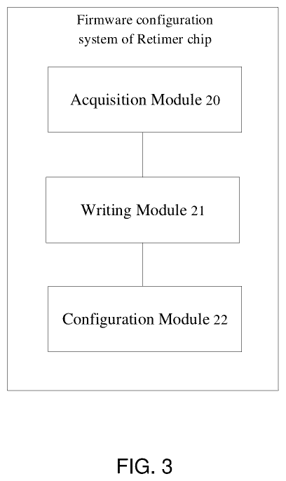

As shown in FIG. 3, a firmware configuration system of a Retimer chip is provided in this embodiment, which includes an acquisition module 20, a writing module 21 and a configuration module 22.

The acquisition module 21 is configured to acquire a storage in-place signal and a storage node authentication signal.

The writing module 22 is configured to cause a baseboard management controller (BMC) to write corresponding firmware configuration to the Retimer chip based on the storage in-place signal and the storage node authentication signal.

The configuration module 23 is configured to change CPU configuration and a communication link of a storage node based on the storage in-place signal, so that the CPU configuration and the communication link are adapted to the firmware configuration of the Retimer chip.

It should be noted that principles of the acquisition module 20, the writing module 21, and the configuration module 22 are same as those of the above embodiments, which will not be repeated here.

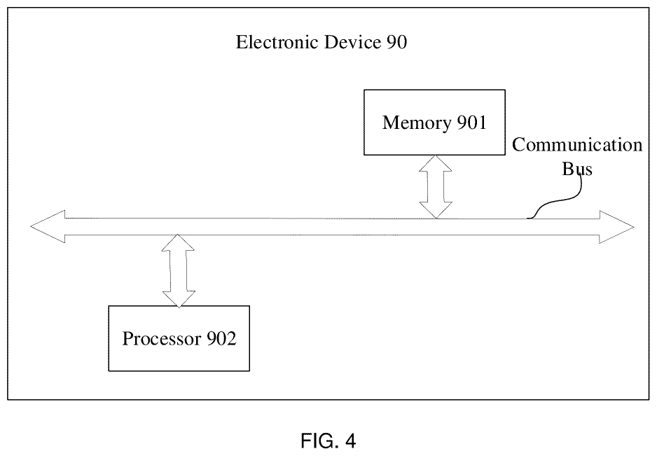

An electronic device is further provided in the present disclosure. As shown in FIG. 4, an electronic device 90 is provided in this embodiment, which includes a memory 901 configured to store a computer program; and a processor 902, which is communicatively connected with the memory 901 and configured to call the computer program to execute the firmware configuration method of the Retimer chip.

The memory 901 includes a ROM (Read Only Memory), a RAM (Random Access Memory), a magnetic disk, a U-disk, a memory card or an optical disk and other media that can store program codes.

The processor 902 is connected with the memory 901 and is configured to execute the computer program stored in the memory 901, so that the electronic device can execute the firmware configuration method of the Retimer chip.

Preferably, the processor 902 can be a general-purpose processor, including a Central Processing Unit (CPU), a Network Processor (NP), etc; or can also be a Digital Signal Processor (DSP), an application specific integrated circuit (ASIC), a Field Programmable Gate Array (FPGA) or other programmable logic devices, discrete gates or transistor logic devices, and discrete hardware components.

In several embodiments provided in the present disclosure, it should be understood that the disclosed system, apparatus or method can be implemented in other ways. For example, the apparatus embodiment described above is only exemplary, for example, division of a module or unit is only a logical function division, and there may be another division mode in actual implementation. For example, a plurality of modules or units may be combined or integrated into another system, or some of the features may be ignored or not executed. On the other hand, mutual coupling or direct coupling or communication connection shown or discussed can be indirect coupling or communication connection through some interfaces, apparatuses or modules or units, which can be in electrical, mechanical or other forms.

Modules/units described as separate components may or may not be physically separated, and components shown as modules/units may or may not be physical modules, that is, they may be located in one place or distributed to multiple network units. Some or all of the modules/units can be selected according to actual needs to achieve purposes of embodiments of the disclosure. For example, respective functional modules/units in respective embodiments of the present disclosure may be integrated into one processing unit, or the respective module/units may physically separately exist, or two or more module/units may be integrated into one module/unit.

It should be further realized by those skilled in the art that units and algorithm steps of respective examples described in connection with the embodiments disclosed herein can be implemented in electronic hardware, computer software or a combination of both. In order to clearly illustrate interchangeability of hardware and software, components and steps of the respective examples have been generally described according to functions in the above description. Whether these functions are implemented in hardware or software depends on specific application and design constraints of the technical scheme. Skilled persons can use different methods to realize the described functions for each specific application, but this implementation should not be considered beyond the scope of the disclosure.

A computer-readable storage medium is further provided in an embodiment of the present disclosure. It can be understood by those of ordinary skill in the art that all or part of steps in the method for realizing the above embodiments can be completed by instructing a processor through a program, and the program can be stored in a computer-readable storage medium which is a non-transitory medium, such as a random access memory, a read-only memory, a flash memory, a hard disk, a solid-state hard disk, a magnetic tape, a floppy disk, an optical disc, or combination thereof. The above storage medium can be any available medium that a computer can access or a data storage device such as a server or a data center containing one or more available media sets. The available medium may be a magnetic medium (e.g., a floppy disk, a hard disk, a magnetic tape), an optical medium (e.g., a digital video disc (DVD)), or a semiconductor medium (e.g., a solid state disk (SSD)) and the like.

A computer program product including one or more computer instructions is further provided in an embodiment of the present disclosure. When the computer instructions are loaded and executed on a computing device, processes or functions described in the embodiments of the disclosure are generated in whole or in part. The computer instructions can be stored in a computer-readable storage medium or transmitted from one computer-readable storage medium to another. For example, the computer instructions can be transmitted from a website, a computer, or a data center to another website, computer, or data center through a wired mode (such as a coaxial cable, an optical fiber, a digital subscriber line (DSL)) or a wireless mode (such as infrared, wireless, microwave, etc.).

When the computer program product is executed by a computer, the computer executes the method described in the aforementioned method embodiment. The computer program product can be a software installation package, and the computer program product can be downloaded and executed on the computer when the aforementioned method is needed.

In the present disclosure, the BMC can be caused to automatically write the corresponding firmware configuration to the Retimer chip according to different application scenarios, so as to realize automatic updating of firmware configuration of the Retimer chip, so that users can freely exchange nodes in position while supporting the NTB firmware configuration and the NTB and PCIe synchronous firmware configuration without changing hardwares, which realizes compatibility between PCIe SSD and NTB, prolongs a communication distance and has strong compatibility and flexibility.

Descriptions of processes or structures corresponding to above figures have their own emphases. For parts not detailed in a certain process or structure, reference can be made to related descriptions of other processes or structures.

The above embodiments only illustrate the principle and efficacy of the present disclosure, but are not intended to limit the present disclosure. The above embodiments can be modified or changed by anyone familiar with this technology without departing from the spirit and scope of the present disclosure. Therefore, all of equivalent modifications or changes made by persons with ordinary knowledge in this art without departing from the spirit and technical ideas disclosed in the present disclosure should still be encompassed by claims of the present disclosure.

1-10. (canceled)

11. A firmware configuration method for a retimer chip, the method comprising:
acquiring a storage in-place signal and a storage node authentication signal;
causing a baseboard management controller (BMC) to write corresponding firmware configuration to the retimer chip based on the storage in-place signal and the storage node authentication signal; and
changing a CPU configuration and a communication link of a storage node based on the storage in-place signal, such that the CPU configuration and the communication link are adapted to the firmware configuration of the retimer chip.

12. The method of claim 11, wherein when an external storage device is not accessed, the BMC is caused to write NTB firmware configuration to the retimer chip based on the storage in-place signal; and
the BMC is caused to write NTB firmware configuration of a first storage node or NTB firmware configuration of a second storage node to the retimer chip based on the storage node authentication signal.

13. The method of claim 11, wherein when an external storage device is accessed, the BMC is caused to write NTB and PCIe synchronous firmware configuration to the retimer chip based on the storage in-place signal; and
the BMC is caused to write NTB and PCIe synchronous firmware configuration of a first storage node or NTB and PCIe synchronous firmware configuration of a second storage node to the retimer chip based on the storage node authentication signal.

14. The method of claim 12, wherein when the external storage device is not accessed, the CPU configuration is changed to the NTB configuration based on the storage in-place signal, so that the CPU configuration is adapted to the NTB firmware configuration of the retimer chip.

15. The method of claim 13, wherein when the external storage device is accessed, the CPU configuration is changed to the NTB and PCIe configuration based on the storage in-place signal, so that the CPU configuration is adapted to the NTB and PCIe synchronous firmware configuration of the retimer chip.

16. The method of claim 12, wherein when the external storage device is not accessed, a communication link switching chip is caused to switch the communication link to an NTB path based on a communication link switching signal, so that the communication link is adapted to the NTB firmware configuration of the retimer chip.

17. The method of claim 13, wherein when the external storage device is accessed, a communication link switching chip is caused to switch the communication link to a PCIe path based on a communication link switching signal, so that the communication link is adapted to the NTB and PCIe synchronous firmware configuration of the retimer chip.

18. A system comprising:
a processor; and
a non-volatile memory have instructions stored thereon which, when executed by the processor, cause the system to:
acquire a storage in-place signal and a storage node authentication signal;
cause a baseboard management controller (BMC) to write corresponding firmware configuration to a retimer chip based on the storage in-place signal and the storage node authentication signal; and
change a CPU configuration and a communication link of a storage node based on the storage in-place signal, such that the CPU configuration and the communication link are adapted to the firmware configuration of the retimer chip.

19. The system of claim 18, wherein when an external storage device is not accessed, the BMC is caused to write NTB firmware configuration to the retimer chip based on the storage in-place signal; and
the BMC is caused to write NTB firmware configuration of a first storage node or NTB firmware configuration of a second storage node to the retimer chip based on the storage node authentication signal.

20. The system of claim 18, wherein when an external storage device is accessed, the BMC is caused to write NTB and PCIe synchronous firmware configuration to the retimer chip based on the storage in-place signal; and
the BMC is caused to write NTB and PCIe synchronous firmware configuration of a first storage node or NTB and PCIe synchronous firmware configuration of a second storage node to the retimer chip based on the storage node authentication signal.

21. The system of claim 19, wherein when the external storage device is not accessed, the CPU configuration is changed to the NTB configuration based on the storage in-place signal, so that the CPU configuration is adapted to the NTB firmware configuration of the retimer chip.

22. The system of claim 19, wherein when the external storage device is accessed, the CPU configuration is changed to an NTB and PCIe configuration based on the storage in-place signal, so that the CPU configuration is adapted to an NTB and PCIe synchronous firmware configuration of the retimer chip.

23. The system of claim 20, wherein when the external storage device is not accessed, a communication link switching chip is caused to switch the communication link to an NTB path based on a communication link switching signal, so that the communication link is adapted to the NTB firmware configuration of the retimer chip.

24. The system of claim 20, wherein when the external storage device is accessed, a communication link switching chip is caused to switch the communication link to a PCIe path based on a communication link switching signal, so that the communication link is adapted to the NTB and PCIe synchronous firmware configuration of the retimer chip.

25. A computer-readable storage medium having a computer program stored thereon, which, when executing by a computer system, cause the computer system to:
acquire a storage in-place signal and a storage node authentication signal;
cause a baseboard management controller (BMC) to write corresponding firmware configuration to a retimer chip based on the storage in-place signal and the storage node authentication signal; and
change a CPU configuration and a communication link of a storage node based on the storage in-place signal, such that the CPU configuration and the communication link are adapted to the firmware configuration of the retimer chip.

26. The computer-readable storage medium of claim 25, wherein when an
external storage device is not accessed, the BMC is caused to write an NTB firmware configuration to the retimer chip based on the storage in-place signal; and
the BMC is caused to write NTB firmware configuration of a first storage node or NTB firmware configuration of a second storage node to the retimer chip based on the storage node authentication signal.

27. The computer-readable storage medium of claim 25, wherein when an external storage device is accessed, the BMC is caused to write NTB and PCIe synchronous firmware configuration to the retimer chip based on the storage in-place signal; and
the BMC is caused to write NTB and PCIe synchronous firmware configuration of a first storage node or NTB and PCIe synchronous firmware configuration of a second storage node to the retimer chip based on the storage node authentication signal.

28. The computer-readable storage medium of claim 26, wherein when the external storage device is not accessed, the CPU configuration is changed to the NTB configuration based on the storage in-place signal, so that the CPU configuration is adapted to the NTB firmware configuration of the retimer chip.

29. The computer-readable storage medium of claim 26, wherein when the external storage device is accessed, the CPU configuration is changed to an NTB and PCIe configuration based on the storage in-place signal, so that the CPU configuration is adapted to an NTB and PCIe synchronous firmware configuration of the retimer chip.

30. The computer-readable storage medium of claim 27, wherein when the external storage device is not accessed, a communication link switching chip is caused to switch the communication link to an NTB path based on a communication link switching signal, so that the communication link is adapted to the NTB firmware configuration of the retimer chip.
